(19) United States
(12) Patent Application Publication
(10) Pub. No.: US 2017/0315053 A1
(43) Pub. Date: Nov. 2, 2017

(54) REFRACTIVE INDEX MEASUREMENT METHOD, REFRACTIVE INDEX MEASUREMENT APPARATUS, AND OPTICAL ELEMENT MANUFACTURING METHOD

(71) Applicant: CANON KABUSHIKI KAISHA, Tokyo (JP)

(72) Inventor: Tomohiro Sugimoto, Yoshikawa-shi (JP)

(21) Appl. No.: 15/484,813

(22) Filed: Apr. 11, 2017

(30) Foreign Application Priority Data
Apr. 28, 2016 (JP) 2016-091587

(51) Int. Cl. G01N 21/45; G01B 9/02

(52) U.S. Cl. CPC G01N 21/45; G01B 9/0201; G01N 2021/458

(57) ABSTRACT

A refractive index measurement method uses an interference optical system which divides light from a light source having a plurality of discrete wavelengths into test light and reference light, causes the test light transmitted through the target to interfere with the reference light, and detect the interference light. The refractive index measurement method determines a first optical delay amount of the interference optical system so that a first and a second wavelength become adjacent to a wavelength corresponding to an extremal value of a phase of the interference light, measures phases of interference light at the first and second wavelengths at the first optical delay amount, and calculates a phase difference between a plurality of the discrete wavelengths at a predetermined optical delay amount using the first optical delay amount, the phases of the interference light at the first and second wavelengths to calculate the refractive index of the target.

### BACKGROUND

### Field of Art

The present disclosure relates to a refractive index measurement method and a refractive index measurement apparatus for measuring the refractive index of an optical element.

### Description of the Related Art

The refractive index of a molded lens changes with molding conditions. The refractive index of a molded lens is generally measured, after being processed into a prism, by the minimum deviation angle method or the V block method. This processing work requires labor and cost. The refractive index of a molded lens further changes with residual stress in the lens being released through processing. Accordingly, to measure the refractive index of the molded lens with sufficient accuracy, a nondestructive measurement technique is required.

With the measurement method disclosed in H. Delbarre, C. Przygodzki, M. Tassou, D. Boucher, “High-precision index measurement in anisotropic crystals using white-light spectral interferometry”, Applied Physics B, 2000, vol. 70, pp. 45-51, light from a wideband continuous spectrum light source is caused to enter a target, and an interference signal between test light transmitted through the target and reference light is measured as a function of wavelength. The refractive index of the target is calculated as a function of the wavelength by the measured interference signal being fitted with a modeling function.

This method requires a wideband high-intensity continuous spectrum light source, which is expensive. A wideband high-intensity discrete spectrum light source is inexpensive, but is difficult to be used because the sampling frequency often becomes lower than the frequency of the interference signal.

### SUMMARY

An aspect of an embodiment is a refractive index measurement method for measuring a refractive index of a target, using an interference optical system which divides light from a light source having a plurality of discrete wavelengths into test light and reference light, causes the test light to enter a target, and causes the test light transmitted through the target and the reference light to interfere with each other, by measuring a phase of interference light between the test light transmitted through the target and the reference light, the refractive index measurement method includes determining a first optical delay amount of the interference optical system so that, in a case where a difference between optical path lengths of the test light and the reference light with the target being not arranged on an optical path of the test light is set as an optical delay amount of the interference optical system, a first wavelength being one of the plurality of discrete wavelengths and a second wavelength, different from the first wavelength, being one of the plurality of discrete wavelengths are included in a wavelength range corresponding to a phase having a difference of less than 2π from an extremal value of the phase of the interference light, measuring a phase of interference light at the first wavelength and a phase of interference light at the second wavelength in a case where the optical delay amount of the interference optical system is the first optical delay amount, calculating a phase difference between the plurality of discrete wavelengths in a case where the optical delay amount of the interference optical system is a predetermined optical delay amount, using the first optical delay amount, the phase of the interference light at the first wavelength, and the phase of the interference light at the second wavelength, and calculating the refractive index of the target based on the phase difference between the plurality of discrete wavelengths.

According to another embodiment, an optical element manufacturing method includes molding an optical element, and measuring the refractive index of the optical element using the above refractive index measurement method to evaluate the optical performance of the molded optical element.

According to yet another embodiment, a refractive index measurement apparatus includes a light source configured to emit light having a plurality of discrete wavelengths, an interference optical system configured to divide the light from the light source into test light and reference light, cause the test light to enter a target, and cause the test light transmitted through the target and the reference light to interfere with each other, a detector configured to detect interference light obtained by the interference of the test light and the reference light caused by the interference optical system, and a computer configured to calculate a refractive index of the target using the phase of the interference light detected by the detector, By using a first optical delay amount of the interference optical system determined so that, in a case where a difference between optical path lengths of the test light and the reference light with the target being not arranged on an optical path of the test light is defined as an optical delay amount of the interference optical system, a first wavelength being one of the plurality of discrete wavelengths and a second wavelength, different from the first wavelength, being one of the plurality of discrete wavelengths are included in a wavelength range corresponding to a phase having a difference of less than 2π from an extremal value of the phase of the interference light, and by using a phase of interference light at the first wavelength and a phase of the interference light at the second wavelength measured in a case where the optical delay amount of the interference optical system is the first optical delay amount, the computer calculates a phase difference between the plurality of discrete wavelengths in a case where the optical delay amount of the interference optical system is a predetermined optical delay amount, and calculates the refractive index of the target based on the phase difference between the plurality of discrete wavelengths.

Further features will become apparent from the following description of exemplary embodiments with reference to the attached drawings.

### BRIEF DESCRIPTION OF THE DRAWINGS

FIG. 1 schematically illustrates a configuration of a refractive index measurement apparatus according to a first exemplary embodiment.

FIGS. 2A and 2B illustrate the intensity of interference light measured in a case where the optical delay amount of an interference optical system is a predetermined optical delay amount according to the first exemplary embodiment.

FIG. 3 is a flowchart illustrating a procedure for measuring the refractive index of a target according to the first exemplary embodiment.

FIGS. 4A to 4D illustrate the intensity and phase of interference light measured in a case where the optical delay amount of the interference optical system is a first optical delay amount according to the first exemplary embodiment.

FIG. 5 schematically illustrates a configuration of a refractive index measurement apparatus according to a second exemplary embodiment.

FIGS. 6A and 6B illustrate a coordinate system defined on a target and the optical path of light within the refractive index measurement apparatus.

FIGS. 7A and 7B illustrate the intensity of interference light measured in a case where the optical delay amount of an interference optical system is a predetermined optical delay amount according to the second exemplary embodiment.

FIG. 8 illustrates a summation signal of an interference signal at the k-th wavelength and an interference signal at the (k+1)-th wavelength according to the second exemplary embodiment.

FIGS. 9A to 9D illustrate the intensity and phase of the interference light measured in a case where the optical delay amount of the interference optical system is the k-th optical delay amount according to the second exemplary embodiment.

FIG. 10 illustrates manufacturing processes in an optical element manufacturing method according to a third exemplary embodiment.

### DESCRIPTION OF THE EMBODIMENTS

Exemplary embodiments will be described below with reference to the accompanying drawings.

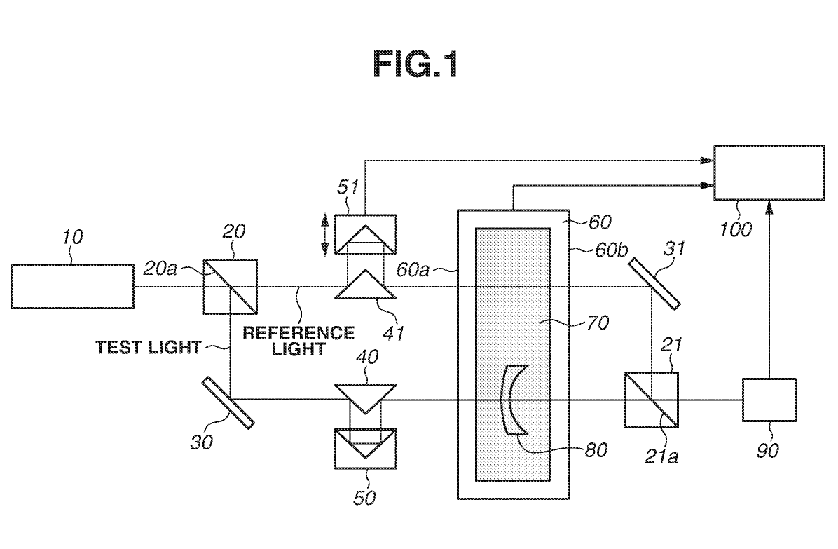

A first exemplary embodiment will be described below. FIG. 1 schematically illustrates a configuration of a refractive index measurement apparatus according to the present exemplary embodiment. The refractive index measurement apparatus according to the first exemplary embodiment is configured based on a Mach-Zehnder interferometer. The refractive index measurement apparatus includes a light source 10, an interference optical system, a container 60 capable of storing a target 80 and a medium 70, a detector 90, and a computer 100, and measures the refractive index of the target 80. The target 80 is a refractive optical element, such as a lens or a flat plate. The refractive index of the medium 70 does not need to coincide with the refractive index of the target 80.

The light source 10 is a light source (discrete spectrum light source) capable of emitting light having a plurality (n different types) of discrete wavelengths, where n is 2 or a larger integer. A light source for emitting light having a plurality of discrete wavelengths may be a single light source oscillating at a plurality of wavelengths (for example, argon (Ar) laser and krypton (Kr) laser) or a combination of a plurality of light sources oscillating at a single wavelength. In a case where a wideband discrete spectrum light source is required, several light sources oscillating at a plurality of wavelengths may be combined (for example, a combination of three different light sources including Kr laser, Ar laser, and helium-neon (HeNe) laser oscillating at a plurality of wavelengths).

The interference optical system splits light from the light source 10 into test light that is to transmit through the target 80 and reference light that does not transmit through the target 80, superposes the test light and the reference light to cause them to interfere with each other, and guides the interference light to the detector 90. The interference optical system includes beam splitters 20 and 21, and mirrors 30, 31, 40, 41, 50, and 51.

The beam splitters 20 and 21 are, for example, cube beam splitters. The beam splitter 20 transmits part of the light from the light source 10 and at the same time reflects the remaining part of the light on an interface (bonding surface) 20a. The light that reflects on the interface 20a is test light, and the light that penetrates the interface 20a is reference light. The beam splitter 21 transmits part of the test light and reflects part of the reference light on an interface 21a. As a result, the test light and the reference light are superposed to form interference light which is guided to the detector 90.

The container 60 stores the medium 70 (for example, oil) and the target 80. It is desirable that the optical path length of the test light coincides with the optical path length of the reference light in a state where the target 80 is not arranged in the container 60. Accordingly, it is desirable that the side panels (e.g., glass) 60a and 60b of the container 60 have a uniform thickness and a uniform refractive index, and are parallel to each other. The container 60 includes a temperature adjustment mechanism (temperature controller) for performing temperature rising and lowering control on the medium 70 and temperature distribution control on the medium 70.

The refractive index of the medium 70 is calculated by a medium refractive index calculator (not illustrated). The medium refractive index calculator includes, for example, a thermometer for measuring the temperature of the medium 70, and a computer for converting the measured temperature into the refractive index of the medium 70. More specifically, the computer may be configured to include a memory storing the refractive index for each wavelength at a specific temperature and a temperature coefficient of the refractive index at each wavelength. Thus, the computer can calculate for each wavelength the refractive index of the medium 70 at the temperature of the medium 70 measured by the thermometer. In a case where the medium 70 has a small temperature variation, a lookup table indicating data about the refractive index for each wavelength at a specific temperature may be used. The medium refractive index calculator may include a glass prism having a known refractive index and a known shape, a wavefront sensor for measuring the transmitted wavefront of the glass prism arranged in the medium 70, and a computer for calculating the refractive index of the medium 70 based on the transmitted wavefront, and the refractive index and shape of the glass prism.

The mirrors 40 and 41 are, for example, prism type mirrors. The mirrors 50 and 51 are, for example, corner cube reflectors. The mirror 51 has a drive mechanism in the direction of the arrow illustrated in FIG. 1. The driving direction is not limited to the direction of the arrow illustrated in FIG. 1, and may be an arbitrary direction as long as the difference between the optical path lengths of the test light and the reference light is changed by driving the mirror 51. The drive mechanism of the mirror 51 includes, for example, a stage having a large driving range and a piezoelectric element having a high driving resolution. The driving amount of the mirror 51 is measured by using a length measuring device (not illustrated), for example, a laser displacement meter and/or an encoder. The drive of the mirror 51 is controlled by the computer 100.

The detector 90 includes a spectrometer for spectrally dispersing the interference light from the beam splitter 21 and detecting the intensity of the interference light as a function of the wavelength (light frequency).

The computer 100 including a central processing unit (CPU) functions not only as a calculator for calculating the refractive index of the target 80 based on the interference signal output from the detector 90 but also as a controller for controlling the driving amount of the mirror 51. However, the calculator for calculating the refractive index of the target 80 based on the interference signal output by the detector 90, and the controller for controlling the driving amount of the mirror 51 and the temperature of the medium 70 may be configured by different computers and/or processors.

The interference optical system is adjusted so that the difference between the optical path lengths of the test light and the reference light (optical delay amount of the interference optical system) becomes zero in a state where the target 80 is not arranged in the container 60. The method for zeroing the optical delay amount of the interference optical system will be described below.

In the refractive index measurement apparatus illustrated in FIG. 1, an interference signal between the test light and the reference light is acquired in a state where the target 80 is not arranged on the optical path of the test light. In such a case, the phase φ₀(λₖ) and the intensity I₀(λₖ) of the interference light are expressed by formula 1.

$$\begin{matrix}[ Formula 1 ] & \\ \begin{matrix}{φ}_{0} ( {λ}_{k} ) = \frac{2 π}{{λ}_{k}} ( - Δ ) \\ {I}_{0} ( {λ}_{k} ) = {I}_{0 k} ( 1 + {γ}_{k} cos {φ}_{0} ( {λ}_{k} ) )\end{matrix} ( k = 1 , 2 , … , n ) & ( 1 )\end{matrix}$$

In formula 1, k denotes an integer from 1 to n, λₖ denotes the k-th wavelength in the air (k-th wavelength), and Δ denotes the difference between the optical path lengths of the test light and the reference light (optical delay amount of the interference optical system) in a state where the target 80 is not arranged on the optical path of the test light. I₀ₖ denotes the sum of the intensity of the test light and the intensity of the reference light at the k-th wavelength, and γₖ denotes a visibility at the k-th wavelength. Referring to formula 1, since the refractive index of the air is included in the wavelength λₖ, the optical delay amount Δ is equal to the difference between the geometrical distances of the optical paths of the test light and the reference light.

Referring to formula 1, in a case where the optical delay amount Δ of the interference optical system is not zero, the intensity I₀(λₖ) becomes an oscillating function. Accordingly, to equalize the optical path lengths of the test light and the reference light, the mirror 51 needs to be driven to a position where the interference signal does not become an oscillating function (a position where the intensity I₀(λₖ) becomes constant with respect to the wavelength). In this case, the optical delay amount Δ of the interference optical system becomes zero. According to the first exemplary embodiment, the optical delay amount Δ=Δ₀ is defined as a predetermined optical delay amount. The predetermined optical delay amount Δ₀ may be an arbitrary value.

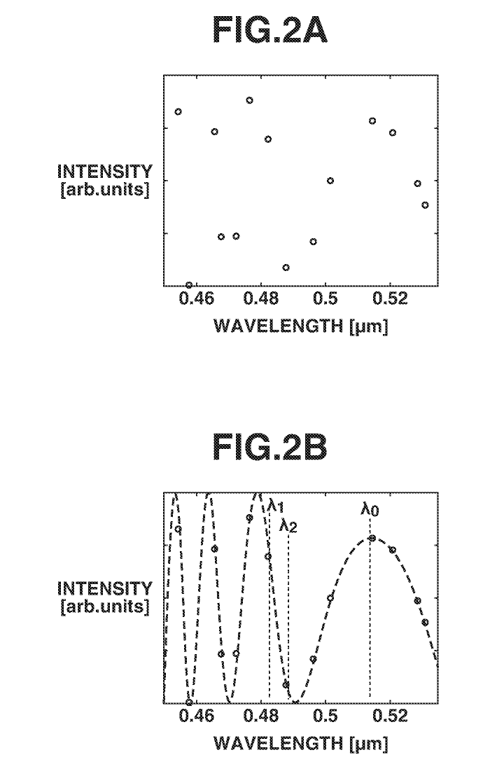

FIG. 2A illustrates an interference signal measured in a state where the target 80 is arranged on the optical path of the test light in a case where the optical delay amount of the interference optical system is the predetermined optical delay amount Δ₀. The interference signal illustrated in FIGS. 2A and 2B are normalized in terms of the intensity at each wavelength. According to the present exemplary embodiment, since a discrete spectrum light source is used, a discrete interference signal can be acquired. In a case where the optical delay amount of the interference optical system is the predetermined optical delay amount Δ₀, the phase φ(λₖ,Δ₀) and the intensity I(λₖ,Δ₀) of the interference light are represented by formula 2.

$$\begin{matrix} [ Formula 2 ] & \\ \begin{matrix}φ ( {λ}_{k} , {Δ}_{0} ) = \frac{2 π}{{λ}_{k}} [ ( {n}^{sample} ( {λ}_{k} ) - {n}^{medium} ( {λ}_{k} ) ) L - {Δ}_{0} ] \\ I ( {λ}_{k} , {Δ}_{0} ) = {I}_{0 k} ( 1 + {γ}_{k} cos φ ( {λ}_{k} ) )\end{matrix} ( k = 1 , 2 , … , n ) & ( 2 )\end{matrix}$$

In formula 2, n^{sample}(λₖ) denotes the refractive index of the target 80, n^{medium}(λₖ) denotes the refractive index of the medium 70, and L denotes the geometrical thickness of the target 80 at the point of measurement.

FIG. 2B illustrates a graph in which a dashed line representing the interference signal obtained with a continuous light source being used is added to FIG. 2A, to facilitate understanding of variations of the interference signal depending on the wavelength. FIG. 2B illustrates that the period of the interference signal serves as a function of the wavelength. P(λ,Δ₀), the period at a particular wavelength λ of the interference signal, is represented by formula 3 including the phase φ(λ,Δ₀).

$$\begin{matrix}[ Formula 3 ] & \\ P ( λ , {Δ}_{0} ) = \frac{2 π}{d φ ( λ , {Δ}_{0} ) / d λ} & ( 3 )\end{matrix}$$

Formula 3 indicates that the period P (λ,Δ₀) is the longest at the wavelength corresponding to the extremal values of the phase φ(λ,Δ₀) at which dφ(λ,Δ₀)/dλ=0. The wavelength λ₀ illustrated in FIG. 2B represents the wavelength corresponding to the extremal value of the phase φ(λ,Δ₀). With the optical delay amount Δ of the interference optical system varying, the wavelength λ₀ corresponding to the extremal value also varies.

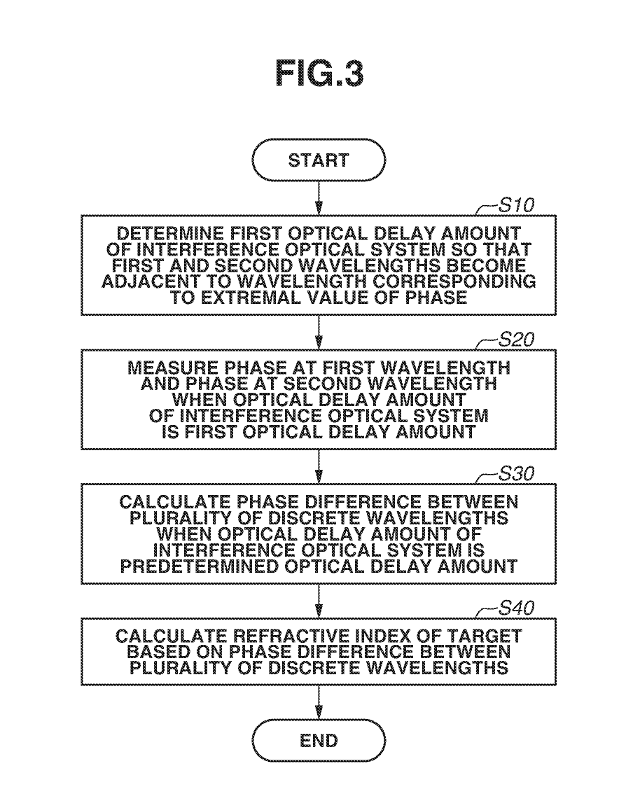

FIG. 3 is a flowchart illustrating a procedure for measuring the refractive index of the target 80.

In step S10, the CPU determines a first optical delay amount Δ₁ of the interference optical system so that a first wavelength λ₁ and a second wavelength λ₂ different from the first wavelength λ₁ become adjacent to a wavelength λ₀ corresponding to an extremal value of the phase of the interference light. A wavelength adjacent to the wavelength λ₀ refers to a wavelength range corresponding to a phase having a difference of less than 2π from the phase of one of the extremal values. According to the present exemplary embodiment, this means that the difference between the phase at the first wavelength λ₁ and the phase at the wavelength λ₀ is less than 2π, and that the difference between the phase at the second wavelength λ₂ and the phase at the wavelength λ₀ is less than 2π. Further, it is desirable that, in a case where the optical delay amount Δ of the interference optical system is the first optical delay amount Δ₁, the difference between the phase at the first wavelength λ₁ and the phase at the second wavelength λ₂ is less than π. More specifically, it is desirable that conditions |φ(λ₁,Δ₁)−φ(λ₀,Δ₁)|<2π, |φ(λ₂,Δ₁)−φ(λ₀,Δ₁)|<2π, |φ(λ₁,Δ₁)−φ(λ₂,Δ₁)|<π are satisfied.

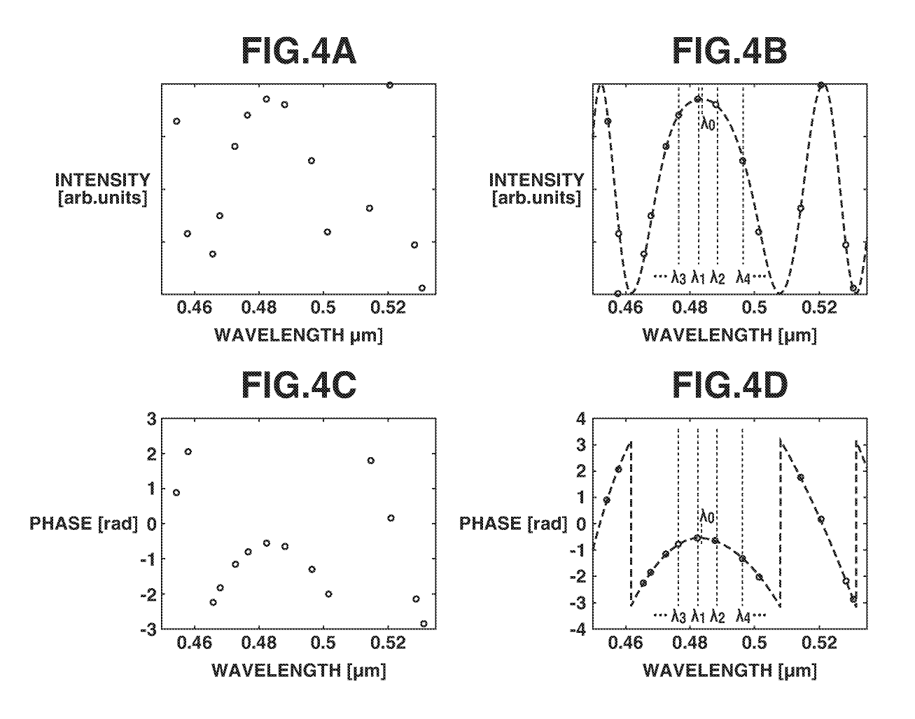

FIG. 4A illustrates the interference signal in a case where the optical delay amount Δ of the interference optical system is set to the first optical delay amount Δ₁ (Δ=Δ₁). FIG. 4B illustrates the graph in which an auxiliary line indicating variations of the interference signal depending on the wavelength is added to FIG. 4A.

In step S20, the CPU measures the phase of the interference light at the first wavelength, φ(λ₁,Δ₁), and the phase of the interference light at the second wavelength, φ(λ₂,Δ₁), in a case where the optical delay amount Δ of the interference optical system is the first optical delay amount Δ₁ by using the following phase shift method.

An interference signal is acquired while the mirror 51 is being driven by a minute amount. In a case where a phase shift amount (i.e., driving amount x 2π/λ) of the mirror 51 is δⱼ (j=0, 1, . . . , M−1), an interference intensity Iⱼ (λₖ,Δ₁) at the k-th wavelength is represented by formula 4.

$$\begin{matrix} [ Formula 4 ] & \\ {I}_{j} ( {λ}_{k} , {Δ}_{1} ) = {I}_{0 k} ⌊ 1 + {γ}_{k} cos ( φ ( {λ}_{k} , {Δ}_{1} ) - {δ}_{j} ) ⌋ = {a}_{0} + {a}_{1} cos {δ}_{j} + {a}_{2} sin {δ}_{j} \\ ( \begin{matrix}{a}_{0} = {I}_{0 k} , {a}_{1} = {I}_{0 k} {γ}_{k} cos φ ( {λ}_{k} , {Δ}_{1} ) , {a}_{2} = {I}_{0 k} {γ}_{k} sin φ ( {λ}_{k} , {Δ}_{1} ) , \\ k = 1 , 2 , … , n , j = 0 , 1 , 2 , … , M - 1\end{matrix} ) & ( 4 )\end{matrix}$$

The phase of the interference light at the k-th wavelength, φ(λₖ,Δ₁), is calculated by formula 5 including the phase shift amount δⱼ and the interference intensity Iⱼ (λₖ,Δ₁). The phase of the interference light may be measured at up to n discrete wavelengths. In which n is an integer of 2 or more including but not limited to: 2, 3, 4, 5, 10, 20, and 100. According to the present exemplary embodiment, not only the phase at the first wavelength, φ(λ₁,Δ₁), and the phase at the second wavelength, φ(λ₂,Δ₁), but also the phase at the k-th wavelength, φ(λₖ,Δ₁), is simultaneously calculated. FIG. 4C illustrates the phase φ(λₖ,Δ₁) obtained by using formula 5. FIG. 4D illustrates the graph in which auxiliary lines are added to FIG. 4C.

$$\begin{matrix} [ Formula 5 ] & \\ [ \begin{matrix}{\sum }_{j = 0}^{M - 1} 1 & {\sum }_{j = 0}^{M - 1} cos {δ}_{j} & {\sum }_{j = 0}^{M - 1} sin {δ}_{j} \\ {\sum }_{j = 0}^{M - 1} cos {δ}_{j} & {\sum }_{j = 0}^{M - 1} {cos}^{2} {δ}_{j} & {\sum }_{j = 0}^{M - 1} cos {δ}_{j} sin {δ}_{j} \\ {\sum }_{j = 0}^{M - 1} sin {δ}_{j} & {\sum }_{j = 0}^{M - 1} cos {δ}_{j} sin {δ}_{j} & {\sum }_{j = 0}^{M - 1} {sin}^{2} {δ}_{j}\end{matrix} ] [ \begin{matrix}{a}_{0} \\ {a}_{1} \\ {a}_{2}\end{matrix} ] = [ \begin{matrix}{\sum }_{j = 0}^{M - 1} {I}_{j} ( {λ}_{k} , {Δ}_{1} ) \\ {\sum }_{j = 0}^{M - 1} {I}_{j} ( {λ}_{k} , {Δ}_{1} ) cos {δ}_{j} \\ {\sum }_{j = 0}^{M - 1} {I}_{j} ( {λ}_{k} , {Δ}_{1} ) sin {δ}_{j}\end{matrix} ] \\ φ ( {λ}_{k} , {Δ}_{1} ) = {tan}^{- 1} \frac{{a}_{2}}{{a}_{1}} = \frac{2 π}{{λ}_{k}} [ ( {n}^{sample} ( {λ}_{k} ) - {n}^{medium} ( {λ}_{k} ) ) L - {Δ}_{1} ] - 2 π {m}_{1} ( {λ}_{k} ) \\ ( k = 1 , 2 , … , n ) & ( 5 )\end{matrix}$$

A technique for increasing the phase calculation accuracy is to decrease the phase shift amount δ₁ as small as possible and increase the number of drive steps M as large as possible. The number of drive steps M is at least 2 and may be much larger. The phase difference obtained by the phase shift method includes an unknown value 2πm₁(λₖ) which is an integral multiple of 2π, where m₁(λₖ) is an integer dependent on the wavelength).

In step S30, based on the first optical delay amount Δ₁, the phase of the interference light at the first wavelength, φ(λ₁,Δ₁), and the phase of the interference light at the second wavelength, φ(λ₂,Δ₁), the CPU calculates the phase difference between a plurality of the discrete wavelengths in a case where the optical delay amount Δ of the interference optical system is the predetermined optical delay amount Δ₀. According to the present exemplary embodiment, the method for calculating the phase difference between a plurality of the discrete wavelengths in a case where the optical delay amount Δ of the interference optical system is the predetermined optical delay amount Δ, i.e., φ(λₚ,Δ₀)−φ(λ_{q},Δ₀) (p=1, 2, . . . , n, q=1, 2, . . . , n), will be described below.

In a case where Δ=Δ₁, since the first wavelength λ₁ and the second wavelength λ₂ are adjacent to the wavelength λ₀ corresponding to the extremal value, there is no phase jump of an integral multiple of 2π between the first wavelength λ₁ and the second wavelength λ₂, i.e., m₁(λ₂)=m₁(λ₁). Accordingly, the phase difference between the phase at the first wavelength, φ(λ₁,Δ₁), and the phase at the second wavelength, φ(λ₂,Δ₁), i.e., φ(λ₂,Δ₁)−φ(λ₁,Δ₁), is calculated with formula 6.

$$\begin{matrix} [ Formula 6 ] & \\ φ ( {λ}_{2} , {Δ}_{1} ) - φ ( {λ}_{1} , {Δ}_{1} ) = 2 π \{ [ ( \frac{{n}^{sample} ( {λ}_{2} )}{{λ}_{2}} - \frac{{n}^{sample} ( {λ}_{1} )}{{λ}_{1}} ) - ( \frac{{n}^{medium} ( {λ}_{2} )}{{λ}_{2}} - \frac{{n}^{medium} ( {λ}_{1} )}{{λ}_{1}} ) ] L - ( \frac{1}{{λ}_{2}} - \frac{1}{{λ}_{1}} ) {Δ}_{1} \} & ( 6 )\end{matrix}$$

As illustrated in FIGS. 4A to 4D, the third wavelength Δ₃ and the fourth wavelength λ₄ are adjacent to the first wavelength λ₁ and the second wavelength λ₂, respectively. The phase difference between the phases at the first and the third wavelengths, i.e., φ(λ₃,Δ₁)−φ(λ₁,Δ₁), and the phase difference between the phases at the second and the fourth wavelengths, i.e., φ(λ₄,Δ₁)−φ(λ₂,Δ₁), are calculated with formula 7.

$$\begin{matrix} [ Formula 7 ] & \\ φ ( {λ}_{3} , {Δ}_{1} ) - φ ( {λ}_{1} , {Δ}_{1} ) = 2 π \{ [ ( \frac{{n}^{sample} ( {λ}_{3} )}{{λ}_{3}} - \frac{{n}^{sample} ( {λ}_{1} )}{{λ}_{1}} ) - ( \frac{{n}^{medium} ( {λ}_{3} )}{{λ}_{3}} - \frac{{n}^{medium} ( {λ}_{1} )}{{λ}_{1}} ) ] L - ( \frac{1}{{λ}_{3}} - \frac{1}{{λ}_{1}} ) {Δ}_{1} \} - 2 π ( {m}_{1} ( {λ}_{3} ) - {m}_{1} ( {λ}_{1} ) ) \\ φ ( {λ}_{4} , {Δ}_{1} ) - φ ( {λ}_{2} , {Δ}_{1} ) = 2 π \{ [ ( \frac{{n}^{sample} ( {λ}_{4} )}{{λ}_{4}} - \frac{{n}^{sample} ( {λ}_{2} )}{{λ}_{2}} ) - ( \frac{{n}^{medium} ( {λ}_{4} )}{{λ}_{4}} - \frac{{n}^{medium} ( {λ}_{2} )}{{λ}_{2}} ) ] L - ( \frac{1}{{λ}_{4}} - \frac{1}{{λ}_{2}} ) {Δ}_{1} \} - 2 π ( {m}_{1} ( {λ}_{4} ) - {m}_{1} ( {λ}_{2} ) ) & ( 7 )\end{matrix}$$

The phase jump amount 2π(m₁(λ₃)−m₁(λ₁)) in formula 7 can be calculated with an approximate value φ(λ₃,Δ₁)−φ(λ₁,Δ₁) represented by formula 8 estimated from a change rate of the phase between the first and the second wavelengths, i.e., [φ(λ₂,Δ₁)−φ(λ₁,Δ₁)]/(λ₂−λ₁).

Similarly, the phase jump amount 2π(m₁(λ₄)−m₁(λ₂) in formula 7 can be calculated with the approximate value φ(λ₄,Δ₁)−φ(λ₂,Δ₁) in formula 8 estimated from the change rate of the phase between the first and the second wavelengths, i.e., [φ(λ₂,Δ₁)−φ(λ₁,Δ₁)]/(λ₂−λ₁).

$$\begin{matrix}[ Formula 8 ] & \\ φ ( {λ}_{3} , {Δ}_{1} ) - φ ( {λ}_{1} , {Δ}_{1} ) \sim - \frac{φ ( {λ}_{2} , {Δ}_{1} ) - φ ( {λ}_{1} , {Δ}_{1} )}{{λ}_{2} - {λ}_{1}} ( {λ}_{1} - {λ}_{3} ) \\ φ ( {λ}_{4} , {Δ}_{1} ) - φ ( {λ}_{2} , {Δ}_{1} ) \sim \frac{φ ( {λ}_{2} , {Δ}_{1} ) - φ ( {λ}_{1} , {Δ}_{1} )}{{λ}_{2} - {λ}_{1}} ( {λ}_{4} - {λ}_{2} ) & ( 8 )\end{matrix}$$

Similarly, the phase difference between a plurality of the discrete wavelengths when Δ=Δ₁, i.e., φ(λₚ,Δ₁)−φ(λ_{q},Δ₁), is calculated with formula 9 by successively calculating φ(λ₅,Δ₁)−φ(λ₃,Δ₁), φ(λ₆,Δ₁)−φ(λ₄,Δ₁), . . . . From the first optical delay amount Δ₁ and the phase difference φ(λₚ,Δ₁)−φ(λ_{q},Δ₁), the phase difference between a plurality of the discrete wavelengths when Δ=Δ₀, i.e., φ(λₚ,Δ₀)−φ(λ_{q},Δ₀) (p=1, 2, . . . , n, q=1, 2, . . . , n), is calculated with formula 10.

$$\begin{matrix} [ Formula 9 ] & \\ φ ( {λ}_{p} , {Δ}_{1} ) - φ ( {λ}_{q} , {Δ}_{1} ) = 2 π \{ [ ( \frac{{n}^{sample} ( {λ}_{p} )}{{λ}_{p}} - \frac{{n}^{sample} ( {λ}_{q} )}{{λ}_{q}} ) - ( \frac{{n}^{medium} ( {λ}_{p} )}{{λ}_{p}} - \frac{{n}^{medium} ( {λ}_{q} )}{{λ}_{q}} ) ] L - ( \frac{1}{{λ}_{p}} - \frac{1}{{λ}_{q}} ) {Δ}_{1} \} - 2 π ( {m}_{1} ( {λ}_{p} ) - {m}_{1} ( {λ}_{q} ) ) & ( 9 ) \\ ( p = 1 , 2 , … , n , q = 1 , 2 , … , n ) & \\ [ Formula 10 ] & \\ φ ( {λ}_{p} , {Δ}_{0} ) - φ ( {λ}_{q} , {Δ}_{0} ) = φ ( {λ}_{p} , {Δ}_{1} ) - φ ( {λ}_{q} , {Δ}_{1} ) + 2 π [ ( \frac{1}{{λ}_{p}} - \frac{1}{{λ}_{q}} ) ( {Δ}_{1} - {Δ}_{0} ) + ( {m}_{1} ( {λ}_{p} ) - {m}_{1} ( {λ}_{q} ) ) ] & ( 10 ) \\ ( p = 1 , 2 , … , n , q = 1 , 2 , … , n ) & \end{matrix}$$

In step S40, the CPU calculates the refractive index of the target 80 based on the phase difference between a plurality of the discrete wavelengths when Δ=Δ₀, i.e., φ(λₚ,Δ₀)−φ(λ_{q},Δ₀). The method for calculating the refractive index of the target 80 according to the present exemplary embodiment will be described below.

In a case where a refractive index n^{sample}(λ_{Q}) of the target 80 at a certain wavelength λ_{Q} (Q-th wavelength) is known, the refractive index of the target 80, i.e., n^{sample}(λₚ) (p=1, 2, . . . , n), is calculated with formula 11 based on formulas 9 and 10.

$$\begin{matrix} [ Formula 11 ] & \\ {n}^{sample} ( {λ}_{p} ) = [ \frac{{n}^{sample} ( {λ}_{Q } )}{{λ}_{Q}} + ( \frac{{n}^{medium} ( {λ}_{p} )}{{λ}_{p}} - \frac{{n}^{medium} ( {λ}_{Q} )}{{λ}_{Q}} ) + \frac{φ ( {λ}_{p} , {Δ}_{0} ) - φ ( {λ}_{Q} , {Δ}_{0} )}{2 π L} + ( \frac{1}{{λ}_{p}} - \frac{1}{{λ}_{Q}} ) \frac{{Δ}_{0}}{L} ] {λ}_{p} \\ ( p = 1 , 2 , … , n ) & ( 11 )\end{matrix}$$

In a case where the refractive index n^{sample}(λ_{Q}) is unknown, the refractive index of the target 80 is calculated by using a refractive index N(λ) of the base material of the target 80 provided by a lens material manufacturer. As in formula 12, if the refractive index dispersion of the target 80 is assumed to be equal to the refractive index dispersion of the base material, a relation represented by formula 13 is satisfied. With formulas 9, 10, and 13, the refractive index of the target 80, i.e., n^{sample}(λ_{q}) (q=1, 2, . . . , n), is calculated by formula 14.

$$\begin{matrix} [ Formula 12 ] & \\ \frac{{n}^{sample} ( {λ}_{p} ) - {n}^{sample} ( {λ}_{q} )}{{n}^{sample} ( {λ}_{q} ) - 1} \sim \frac{N ( {λ}_{p} ) - N ( {λ}_{q} )}{N ( {λ}_{q} ) - 1} & ( 12 ) \\ [ Formula 13 ] & \\ \frac{{n}^{sample} ( {λ}_{p} )}{{λ}_{p}} - \frac{{n}^{sample} ( {λ}_{q} )}{{λ}_{q}} = \frac{( N ( {λ}_{p} ) - 1 ) {λ}_{q} - ( N ( {λ}_{q} ) - 1 ) {λ}_{p}}{( N ( {λ}_{q} ) - 1 ) {λ}_{p} {λ}_{q}} {n}^{sample} ( {λ}_{q} ) - \frac{N ( {λ}_{p} ) - N ( {λ}_{q} )}{( N ( {λ}_{q} ) - 1 ) {λ}_{p}} & ( 13 ) \\ [ Formula 14 ] & \\ {n}^{sample} ( {λ}_{q} ) = \frac{( N ( {λ}_{q} ) - 1 ) {λ}_{p} {λ}_{q}}{( N ( {λ}_{p} ) - 1 ) {λ}_{q} - ( N ( {λ}_{q} ) - 1 ) {λ}_{p}} [ \frac{N ( {λ}_{p} ) - N ( {λ}_{q} )}{( N ( {λ}_{q} ) - 1 ) {λ}_{p}} + ( \frac{{n}^{medium} ( {λ}_{p} )}{{λ}_{p}} - \frac{{n}^{medium} ( {λ}_{q} )}{{λ}_{q}} ) + \frac{φ ( {λ}_{p} , {Δ}_{0} ) - φ ( {λ}_{q} , {Δ}_{0} )}{2 π L} + ( \frac{1}{{λ}_{p}} - \frac{1}{{λ}_{q}} ) \frac{{Δ}_{0}}{L} ] \\ ( q = 1 , 2 , … n ) & ( 14 )\end{matrix}$$

The refractive index of the target 80 at an effective wavelength of the p-th wavelength λₚ and the q-th wavelength λ_{q}, i.e., Λ_{pq}=|1/(1/λₚ−1/λ_{q})|, is calculated with formula 16 based on formulas 9, 10, and 15.

$$\begin{matrix} [ Formula 15 ] & \\ \frac{{n}^{sample} ( {λ}_{p} )}{{λ}_{p}} - \frac{{n}^{sample} ( {λ}_{q} )}{{λ}_{q}} = ( \frac{1}{{λ}_{p}} - \frac{1}{{λ}_{q}} ) ( {n}^{sample} ( {λ}_{q} ) - {λ}_{q} \frac{{n}^{sample} ( {λ}_{p} ) - {n}^{sample} ( {λ}_{q} )}{{λ}_{p} - {λ}_{q}} ) & ( 15 ) \\ [ Formula 16 ] & \\ {n}^{sample} ( {λ}_{q} ) - {λ}_{q} \frac{{n}^{sample} ( {λ}_{p} ) - {n}^{sample} ( {λ}_{q} )}{{λ}_{p} - {λ}_{q}} = [ ( \frac{{n}^{medium} ( {λ}_{p} )}{{λ}_{p}} - \frac{{n}^{medium} ( {λ}_{q} )}{{λ}_{q}} ) + \frac{φ ( {λ}_{p} , {Δ}_{0} ) - φ ( {λ}_{q} , {Δ}_{0} )}{2 π L} + ( \frac{1}{{λ}_{p}} - \frac{1}{{λ}_{q}} ) \frac{{Δ}_{0}}{L} ] / ( \frac{1}{{λ}_{p}} - \frac{1}{{λ}_{q}} ) & ( 16 ) \\ ( p = 1 , 2 , … , n , q = 1 , 2 , … , n ) & \end{matrix}$$

The use of the discrete spectrum light source 10 instead of a continuous light source (e.g., a supercontinuum light source) leads to a discrete phase spectrum as illustrated in FIG. 4C. In a discrete phase spectrum, it is hard to identify a portion where a phase jump of an integral multiple of 2π exists. More specifically, it is difficult to calculate the phase difference between a plurality of wavelengths. According to the present exemplary embodiment, the phase difference between the phases at the first and the second wavelengths, i.e., φ(λ₂,Δ₁)−φ(λ₁,Δ₁), is calculated focusing on the fact that a phase jump of an integral multiple of 2π does not occur in the phase difference between discrete wavelengths adjacent to the wavelength λ₀ corresponding to the extremal value. This makes it possible to calculate the phase difference between a plurality of the discrete wavelengths by using the phase difference φ(λ₂,Δ₁)−φ(λ₁,Δ₁) as an initial value. The use of the refractive index measurement apparatus according to the present exemplary embodiment enables calculation of the refractive index of the target 80 with an inexpensive discrete spectrum light source.

Although, in the present exemplary embodiment, measurement is performed with the target 80 immersed in the medium 70, measurement may be performed in the air. However, in performing measurement in the air, it is desirable to arrange a compensation plate having almost the same refractive index and thickness as those of the target 80 on the optical path of the reference light.

Although, in the present exemplary embodiment, a configuration of a Mach-Zehnder interferometer is employed, a configuration of a Michelson interferometer may be used instead. Although, in the present exemplary embodiment, the refractive index and the phase are calculated as functions of the wavelength, they may be calculated as functions of the light frequency instead.

Although, in the present exemplary embodiment, the first and the second wavelengths are two adjacent wavelengths out of the wavelengths of the discrete spectrum light source 10, the first and the second wavelengths may not be two adjacent wavelengths. For example, referring to FIGS. 4A to 4D, the wavelength λ₃ may be used as the first wavelength, and the wavelength λ₄ the second wavelength.

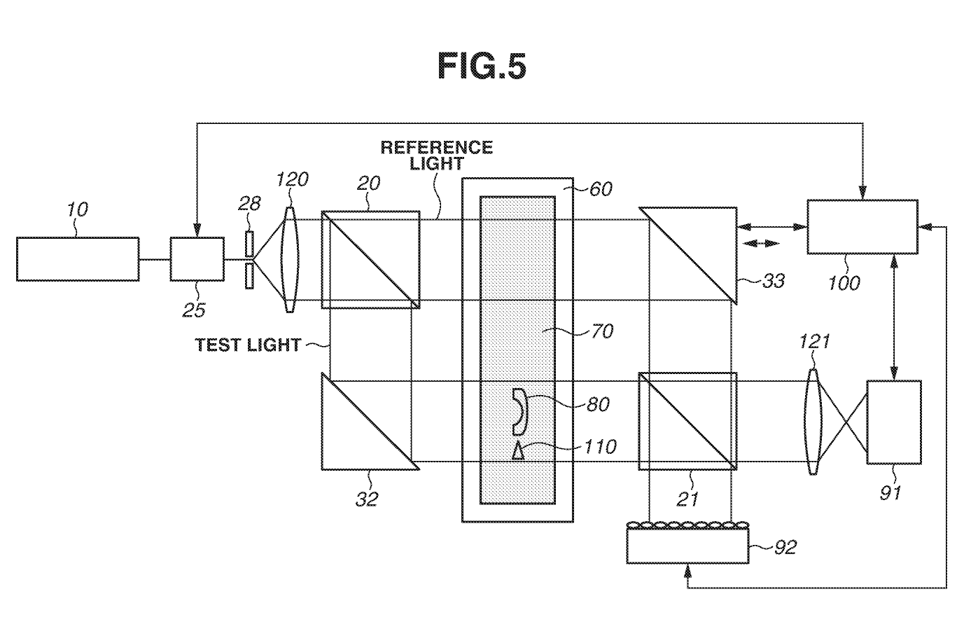

A second exemplary embodiment will be described below. FIG. 5 illustrates an overall configuration of a refractive index measurement apparatus according to the present exemplary embodiment. The refractive index measurement apparatus includes a light source 10, a Mach-Zehnder interference optical system, a container 60 capable of storing a target 80, a medium 70, and a reference object (glass prism) 110, a detector 91, a wavefront sensor 92, and a computer 100, and measures the refractive index of the target 80. According to the present exemplary embodiment, the target 80 is a concave meniscus lens having a refractive index n_{d} of approximately 1.8, and the media 70 is oil having a refractive index n_{d} of approximately 1.7.

The light source 10 is a light source, for example, a combination of Ar laser and HeNe laser oscillating at a plurality of wavelengths, capable of emitting light having a plurality of (n different) discrete wavelengths (n is 2 or a larger integer). Light having a plurality of wavelengths transmits through a monochromator 25 to become quasi-monochromatic light. The light that has transmitted through the monochromator 25 passes through a pinhole 28 to become a divergent wave which transmits through a collimator lens 120 to become parallel light.

The interference optical system includes beam splitters 20 and 21 and mirrors 32 and 33. The interference optical system splits the light that has transmitted through the collimator lens 120 into test light and reference light, causes them to interfere with each other, and guides the interference light to the detector 91. The interference optical system guides the test light to the wavefront sensor 92.

The container 60 stores the target 80, the medium 70, and the glass prism (reference object) 110 having a known refractive index and a known shape. Part of the test light entering the container 60 transmits through the medium 70 and target 80, and another part of the test light transmits through the medium 70 and the glass prism 110. Other part of the test light entering the container 60 transmits only through the medium 70. The reference light that has transmitted through the beam splitter 20 transmits through the medium 70 and then reflects on the mirror 33. The test light and the reference light are superposed by the beam splitter 21 to form interference light. The refractive index of the medium 70 is calculated based on the transmitted wavefront, the refractive index, and the shape of the reference object 110 arranged in the medium 70.

The mirror 33 is driven in the direction of the arrow illustrated in FIG. 5 by a drive mechanism (not illustrated). The driving direction is not limited to the direction of the arrow illustrated in FIG. 5, and may be an arbitrary direction as long as the difference between the optical path lengths of the test light and the reference light is changed by the mirror 33 being driven. The drive mechanism of the mirror 33 includes, for example, a piezo stage. The driving amount of the mirror 33 is measured with a length measuring device (not illustrated) and controlled by the computer 100.

The interference light formed by the beam splitter 21 is detected by the detector 91, such as a charge coupled device (CCD) sensor and a complementary metal-oxide semiconductor (CMOS) sensor, through an imaging lens 121. An interference signal detected by the detector 91 is transmitted to the computer 100. The detector 91 is arranged at a position conjugate to the position of the target 80 and the reference object 110 with respect to the imaging lens 121.

According to the present exemplary embodiment, since the target 80 and the medium 70 have different refractive indices, most of interference fringes formed by the test light that transmits through the target 80 and the reference light become so dense that cannot be decomposed by the detector 91. Accordingly, the detector 91 cannot measure most of interference fringes formed by the test light that transmits through the target 80 and the reference light. However, according to the present exemplary embodiment, the detector 91 does not need to detect interference signals of all of transmitted light of the target 80. The detector 91 needs to detect the interference signal related to the test light that transmits through the medium 70 and the reference object 110, and the interference signal related to the test light that transmits through the center of the target 80.

Part of the test light that transmits through the target 80 is reflected by the beam splitter 21 and then detected by the wavefront sensor 92 (e.g., a Shack-Hartmann sensor). In measuring the wavefront of the target 80 with the wavefront sensor 92, the test light and the reference light that do not transmit through the target 80 are unnecessary light. Accordingly, unnecessary light is shielded so as not to enter the wavefront sensor 92 using an aperture or a shutter (not illustrated). The signal detected by the wavefront sensor 92 is transmitted to the computer 100 and then calculated as a transmitted wavefront of the test light that transmits through the target 80.

The computer 100 including a CPU includes the calculator for calculating the refractive index of the target based on a detection result of the detector 91 and a detection result of the wavefront sensor 92, and the controller for controlling the wavelength that transmits through the monochromator 25 and the driving amount of the mirror 33.

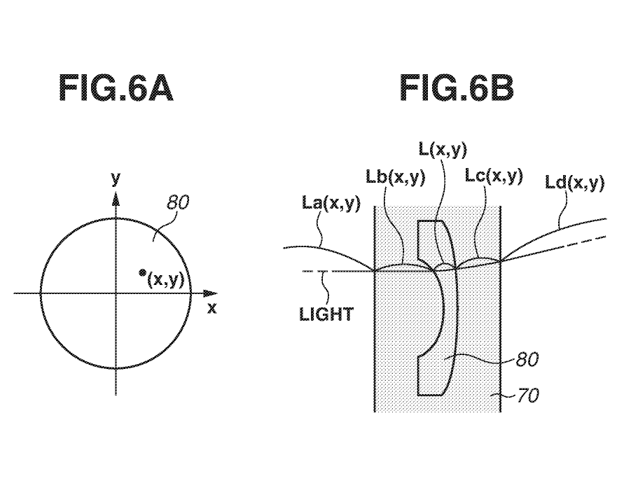

FIG. 6A illustrates a coordinate system defined on the target 80. For example, the center of the target 80 is represented as a point (0,0). FIG. 6B illustrates an optical path related to the test light that passes through a point (x,y) illustrated in FIG. 6A.

According to the present exemplary embodiment, the wavelengths of the test light and the reference light are selected using the monochromator 25, and the phase of the interference light at each wavelength is measured. The phase φ(λₖ,0,0,Δ) and the intensity I(λₖ,0,0,Δ) of the interference light between the test light that transmits through the center of the target 80 and the reference light, to be measured in the present exemplary embodiment, are represented by formula 17.

$$\begin{matrix} [ Formula 17 ] & \\ φ ( {λ}_{k} , 0 , 0 , Δ ) = \frac{2 π}{{λ}_{k}} [ ( {n}^{sample} ( {λ}_{k} , 0 , 0 ) - {n}^{medium} ( {λ}_{k} ) ) L ( 0 , 0 ) - Δ ] - 2 π m ( {λ}_{k} ) & ( 17 ) \\ I ( {λ}_{k} , 0 , 0 , Δ ) = {I}_{0 k} [ 1 + {γ}_{k} cos φ ( {λ}_{k} , 0 , 0 , Δ ) ] ( k = 1 , 2 , … , n ) & \end{matrix}$$

n^{sample}(λₖ,0,0) denotes the refractive index of the center of the target 80, L(0,0) denotes the thickness of the center of the target, Δ denotes the difference between the optical path lengths of the test light and the reference light (optical delay amount of the interference optical system) when the target 80 is not arranged on the optical path of the test light, and m(λₖ) denotes an unknown integer.

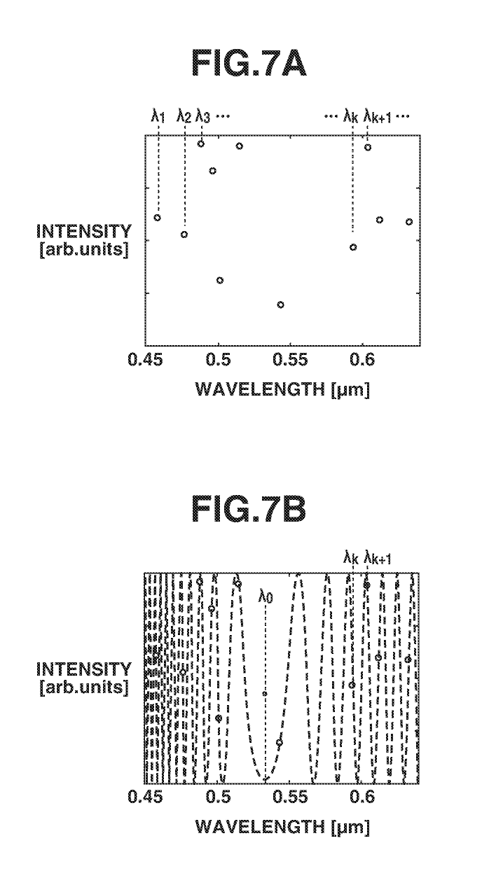

FIG. 7A illustrates an interference signal in a case where the optical delay amount Δ of the interference optical system is set as the predetermined optical delay amount Δ₀. In the present exemplary embodiment, Δ=Δ₀=0 is set as the predetermined optical delay amount. FIG. 7B illustrates the graph in which an auxiliary line indicating variations of the interference signal depending on the wavelength is added to FIG. 7A. FIGS. 7A and 7B represent the normalized intensity of the interference signal. The present exemplary embodiment handles a case where the interference signal varies greatly depending on the wavelength. Unlike the first exemplary embodiment, in the present exemplary embodiment, it is difficult to recognize variations of the interference signal depending on the wavelength only with the graph without an auxiliary line illustrated in FIG. 7A. In other words, it is difficult to distinguish the wavelength λ₀ corresponding to the extremal value of the phase of the interference light.

A flow of refractive index measurement according to the present exemplary embodiment will be described below. In step S10, the CPU determines the k-th optical delay amount of the interference optical system so that the k-th and the (k+1)−th wavelengths become adjacent to the wavelength λ₀ corresponding to the extremal value of the phase of the interference light, where k=1, 2, . . . , n−1. A method for determining the k-th optical delay amount according to the present exemplary embodiment will be described below.

Variations of the interference signal depending on the optical delay amount Δ at the k-th wavelength (k=1, 2, . . . , n), i.e., a Δ dependence I(λₖ,0,0,Δ) of the interference light intensity is measured. The sum of the Δ dependence of the normalized interference light intensity at the k-th wavelength, i.e., I(λₖ,0,0Δ)/I₀ₖ, and the Δ dependence of the standardized interference light intensity at the (k+1)-th wavelength, i.e., I(λₖ₊₁,0,0,Δ)/I₀ₖ₊₁, are represented by formula 18.

$$\begin{matrix} [ Formula 18 ] & \\ I ( {λ}_{k} , 0 , 0 , Δ ) / {I}_{0 k} + I ( {λ}_{k + 1} , 0 , 0 , Δ ) / {I}_{0 k + 1} = 2 + {γ}_{k} cos \frac{φ ( {λ}_{k + 1} , 0 , 0 , Δ ) + φ ( {λ}_{k} , 0 , 0 , Δ )}{2} cos \frac{φ ( {λ}_{k + 1} , 0 , 0 , Δ ) - φ ( {λ}_{k} , 0 , 0 , Δ )}{2} & ( 18 ) \\ ( {γ}_{k} = {γ}_{k + 1} , k = 1 , 2 , … , n - 1 ) & \end{matrix}$$

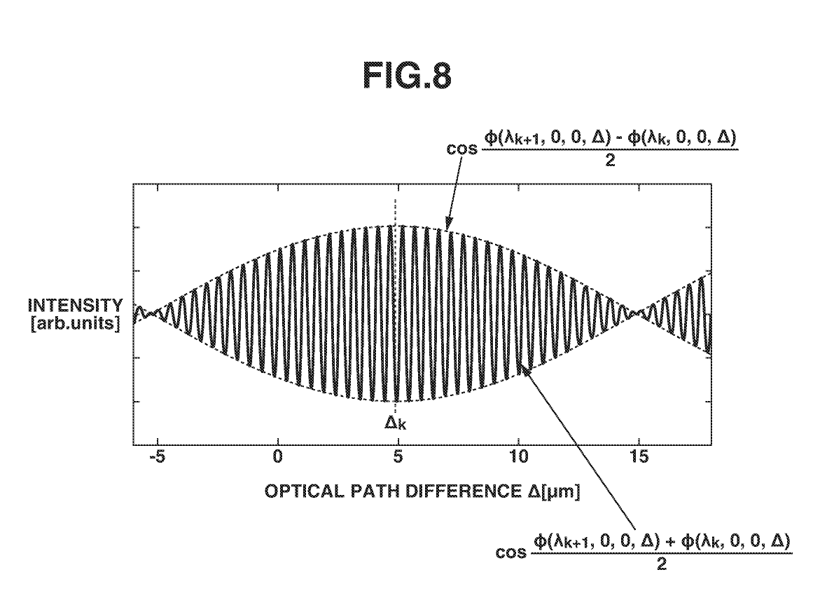

FIG. 8 illustrates the signal of the second term of the right-hand side of formula 18. The second term of the right-hand side of formula 18 includes a carrier wave cos {[φ(λₖ₊₁,0,0,Δ)+φ(λₖ,0,0,Δ)]/2} and a modulated wave cos {[φ(λₖ₊₁,0,0,Δ)−φ(λₖ,0,0, Δ)]/2}. In a case where the phase of the modulated wave indicating an envelope, i.e., [φ(λₖ₊₁,0,0,Δ)−φ(λₖ,0,0,Δ)]/2, is zero, formula 19 is satisfied by the mean value theorem.

$$\begin{matrix} [ Formula 19 ] & \\ \begin{matrix}\frac{d φ ( {λ}_{0} , 0 , 0 , {Δ}_{k} )}{d λ} = \frac{φ ( {λ}_{k + 1} , 0 , 0 , {Δ}_{k} ) - φ ( {λ}_{k} , 0 , 0 , {Δ}_{k} )}{{λ}_{k + 1} - {λ}_{k}} \\ = \frac{2}{{λ}_{k + 1} - {λ}_{k}} \frac{φ ( {λ}_{k + 1} , 0 , 0 , {Δ}_{k} ) - φ ( {λ}_{k} , 0 , 0 , {Δ}_{k} )}{2} = 0\end{matrix} & ( 19 ) \\ ( {λ}_{k} < {λ}_{0} < {λ}_{k + 1} , k = 1 , 2 , … , n - 1 ) & \end{matrix}$$

Referring to formula 19, for the optical delay amount Δₖ with which the phase of the modulated wave becomes zero, the k-th and the (k+1)-th wavelengths become adjacent to the wavelength λ₀ corresponding to the extremal value of the phase. More specifically, as illustrated in FIG. 8, the optical delay amount Δ with which the intensity of the modulated wave is maximized needs to be set as the k-th optical delay amount Δₖ. Although there are a plurality of the optical delay amounts Δ with which the intensity of the modulated wave is maximized, the position of an antinode at which the phase of the modulated wave is 0 can be determined through calculation based on the design value of the target 80 and the refractive index of the medium 70.

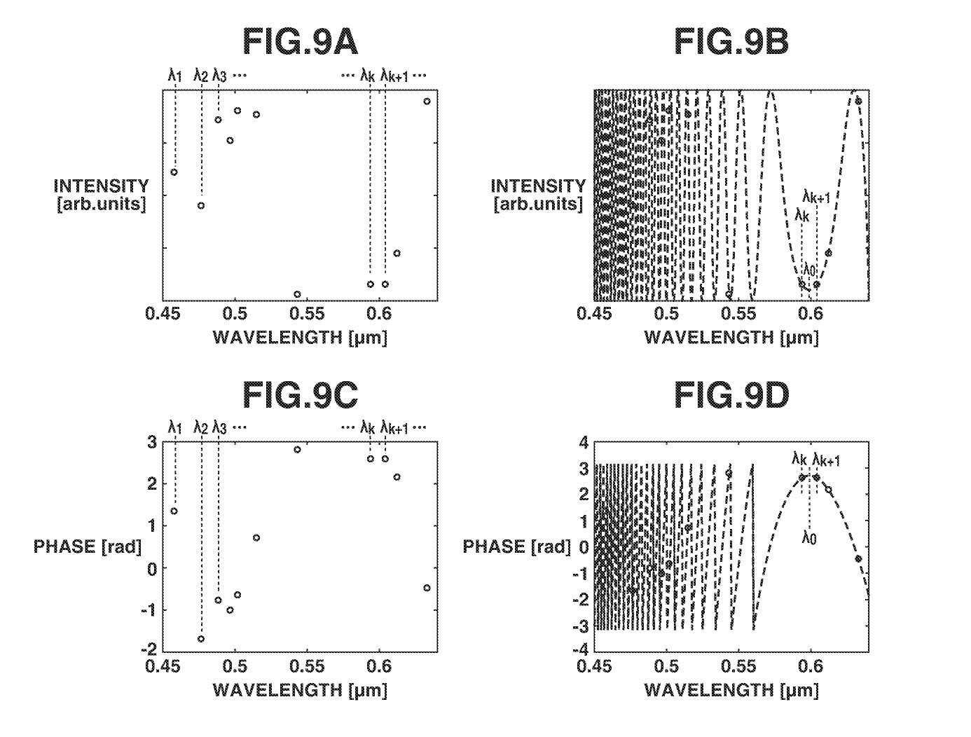

FIG. 9A illustrates the interference signal in a case where Δ=Δₖ is set. FIG. 9B illustrates the graph in which an auxiliary line indicating variations of the interference signal depending on the wavelength is added to FIG. 9A.

In step S20, the phase of the interference light at the k-th wavelength, φ(λₖ,0,0,Δₖ), and the phase of the interference light at the (k+1)-th wavelength, φ(λₖ₊₁,0,0,Δₖ) are measured through the phase shift method with the k-th optical delay amount Δₖ (k=1, 2, . . . , n−1).

FIG. 9C illustrates the phase φ(λₖ, 0,0,Δₖ) in a case where Δ=Δₖ is set. FIG. 9D illustrates the graph in which an auxiliary line indicating variations depending on the wavelength with φ(λₖ, 0,0,Δₖ) is added in FIG. 9C. In a case where the k-th wavelength λₖ and the (k+1)-th wavelength λₖ₊₁ are adjacent to the wavelength λ₀, there is no phase jump of an integral multiple of 2π between φ(λₖ, 0,0,Δₖ) and φ(λₖ₊₁,0,0,Δₖ). Accordingly, the phase difference between the k-th wavelength λₖ and the (k+1)-th wavelength λₖ₊₁ in a case where Δ=Δₖ is calculated by formula 20. Referring to formula 20, the phase difference between the k-th wavelength λₖ and the (k+1)-th wavelength λₖ₊₁ in a case where the optical delay amount Δ of the interference optical system is the predetermined optical delay amount Δ₀=0, i.e., φ(λₖ₊₁,0,0,0)−φ(λₖ,0,0,0), is calculated by formula 21.

$$\begin{matrix} [ Formula 20 ] & \\ φ ( {λ}_{k + 1} , 0 , 0 , {Δ}_{k} ) - φ ( {λ}_{k} , 0 , 0 , {Δ}_{k} ) = 2 π \{ [ ( \frac{{n}^{sample} ( {λ}_{k + 1} , 0 , 0 )}{{λ}_{k + 1}} - \frac{{n}^{sample} ( {λ}_{k} , 0 , 0 )}{{λ}_{k}} ) - ( \frac{{n}^{medium} ( {λ}_{k + 1} )}{{λ}_{k + 1}} - \frac{{n}^{medium} ( {λ}_{k} )}{{λ}_{k}} ) ] L ( 0 , 0 ) - ( \frac{1}{{λ}_{k + 1}} - \frac{1}{{λ}_{k}} ) {Δ}_{k} \} & ( 20 ) \\ ( k = 1 , 2 , … , n - 1 ) & \\ [ Formula 21 ] & \\ φ ( {λ}_{k + 1} , 0 , 0 , 0 ) - φ ( {λ}_{k} , 0 , 0 , 0 ) = φ ( {λ}_{k + 1} , 0 , 0 , {Δ}_{k} ) - φ ( {λ}_{k} , 0 , 0 , {Δ}_{k} ) + 2 π ( \frac{1}{{λ}_{k + 1}} - \frac{1}{{λ}_{k}} ) {Δ}_{k} & ( 21 ) \\ ( k = 1 , 2 , … , n - 1 ) & \end{matrix}$$

In step S30, by using formula 21, the phase difference between a plurality of the discrete wavelengths is measured in a case where the optical delay amount Δ of the interference optical system is the predetermined optical delay amount Δ₀=0, i.e., φ(λₚ,0,0,0)−φ(λ_{q},0,0,0), is calculated through formula 22.

$$\begin{matrix} [ Formula 22 ] & \\ φ ( {λ}_{p} , 0 , 0 , 0 ) - φ ( {λ}_{q} , 0 , 0 , 0 ) = {\sum }_{k = q}^{p - 1} [ φ ( {λ}_{k + 1} , 0 , 0 , 0 ) - φ ( {λ}_{k} , 0 , 0 , 0 ) ] & ( 22 ) \\ ( p > q , p = 2 , … , n , q = 1 , 2 , … , n - 1 ) & \end{matrix}$$

In step S40, the refractive index of the target 80 is measured based on the phase difference between a plurality of the discrete wavelengths. The method for calculating the refractive index of the target 80 according to the present exemplary embodiment will be described below.

First of all, a physical quantity f(λₚ,λ_{q}) represented by formula 23 is obtained based on formulas 20, 21, and 22.

$$[ Formula 23 ]$$

$$( 23 )$$

$$\begin{matrix}f ( {λ}_{p} , {λ}_{q} ) = \frac{{n}^{sample} ( {λ}_{p} , 0 , 0 )}{{λ}_{p}} - \frac{{n}^{sample} ( {λ}_{q} , 0 , 0 )}{{λ}_{q}} \\ = \frac{{n}^{medium} ( {λ}_{p} )}{{λ}_{p}} - \frac{{n}^{medium} ( {λ}_{1} )}{{λ}_{q}} + \frac{φ ( {λ}_{p} , 0 , 0 , 0 ) - φ ( {λ}_{q} , 0 , 0 , 0 )}{2 π L ( 0 , 0 )}\end{matrix}$$

$$( p > q , p = 2 , … , n , q = 1 , 2 , … , n - 1 )$$

Then, a transmitted wavefront Wₛᵢₘ(λₖ,x,y) in a case where a reference target having a uniform refractive index is arranged at the position of the target 80 illustrated in FIG. 5 is calculated by a simulation. Since the refractive index n^{sample}(λ,0,0) of the center of the target 80 is unknown, an estimated value of the refractive index of the center of the target 80, i.e., n^{sample}(λ,0,0)+δₙ(λ), is assumed to be the refractive index of the reference target, where δₙ(λ) denotes an estimated error. Here, a value satisfying formula 24 is selected as the estimated value n^{sample} (λ,0,0)+δₙ(λ). The transmitted wavefront Wₛᵢₘ(λₖ,x,y) (k=p, q) of the reference target is represented by formula 25.

$$\begin{matrix} [ Formula 24 ] & \\ \frac{{n}^{sample} ( {λ}_{p} , 0 , 0 ) + δ n ( {λ}_{p} )}{{λ}_{p}} - \frac{{n}^{sample} ( {λ}_{q} , 0 , 0 ) + δ n ( {λ}_{q} )}{{λ}_{q}} = f ( {λ}_{p} , {λ}_{q} ) & ( 24 ) \\ ( ∴ \frac{δ n ( {λ}_{p} )}{{λ}_{p}} = \frac{δ n ( {λ}_{q} )}{{λ}_{q}} ) & \\ [ Formula 25 ] & \\ {w}_{sim} ( {λ}_{k} , x , y ) = \frac{2 π}{{λ}_{k}} [ {L}_{a} ( x , y ) + {n}^{medium} ( {λ}_{k} ) {L}_{b} ( x , y ) + ( {n}^{sample} ( {λ}_{k} , 0 , 0 ) + δ n ( {λ}_{k} ) ) L ( x , y ) + {n}^{medium} ( {λ}_{k} ) {L}_{c} ( x , y ) + {L}_{d} ( x , y ) ] & ( 25 ) \\ {W}_{sim} ( {λ}_{k} , x , y ) = {w}_{sim} ( {λ}_{k} , x , y ) - {w}_{sim} ( {λ}_{k} , 0 , 0 ) ( k = p , q ) & \end{matrix}$$

Lₐ(x,y), L_{b}(x,y), L_{c}(x,y), and L_{d}(x,y) are surface intervals of optical elements along the light illustrated in FIG. 6B. L(x,y) is the thickness of the target 80 in the beam direction.

The transmitted wavefront Wₘ(λₖ,x,y) of the target 80 measured by the wavefront sensor 92 of the refractive index measurement apparatus illustrated in FIG. 5 is represented by formula 26.

$$\begin{matrix} [ Formula 26 ] & \\ {w}_{m} ( {λ}_{k} , x , y ) = \frac{2 π}{{λ}_{k}} [ {L}_{a} ( x , y ) + {n}^{medium} ( {λ}_{k} ) {L}_{b} ( x , y ) + {n}^{sample} ( {λ}_{k} , x , y ) L ( x , y ) + {n}^{medium} ( {λ}_{k} ) {L}_{c} ( x , y ) + {L}_{d} ( x , y ) ] & ( 26 ) \\ {W}_{m} ( {λ}_{k} , x , y ) = {w}_{m} ( {λ}_{k} , x , y ) - {w}_{m} ( {λ}_{k} , 0 , 0 ) ( k = p , q ) & \end{matrix}$$

A wavefront aberration W(λₖ,x,y) equivalent to the difference between the transmitted wavefront Wₘ(λₖ,x,y) of the target 80 and the transmitted wavefront Wₛᵢₘ(λₖ,x,y) of the reference target is calculated by formula 27.

$$\begin{matrix} [ Formula 27 ] & \\ \begin{matrix}W ( {λ}_{k} , x , y ) = {W}_{m} ( {λ}_{k} , x , y ) - {W}_{sim} ( {λ}_{k} , x , y ) \\ = \frac{2 π}{{λ}_{k}} [ ( {n}^{sample} ( {λ}_{k} , x , y ) - {n}^{sample} ( {λ}_{k} , 0 , 0 ) ) L ( x , y ) - \\ δ n ( {λ}_{k} ) ( L ( x , y ) - L ( 0 , 0 ) ) ]\end{matrix} \\ ( k = p , q ) & ( 27 )\end{matrix}$$

The amount of wavefront aberration difference which is the difference between the wavefront aberration W(λₚ,x,y) at the p-th wavelength and the wavefront aberration W(λ_{q},x,y) at the q-th wavelength is calculated by formula 28 based on formulas 24 and 27.

$$\begin{matrix} [ Formula 28 ] & \\ W ( {λ}_{p} , x , y ) - W ( {λ}_{q} , x , y ) = 2 π ( \frac{{n}^{sample} ( {λ}_{p} , x , y ) - {n}^{sample} ( {λ}_{p} , 0 , 0 )}{{λ}_{p}} - \frac{{n}^{sample} ( {λ}_{q} , x , y ) - {n}^{sample} ( {λ}_{q} , 0 , 0 )}{{λ}_{q}} ) L ( x , y ) & ( 28 )\end{matrix}$$

Here, with an approximate expression represented by formula 29, the refractive index distribution GI(λ_{q},x,y) in the target 80 at the q-th wavelength is calculated by formula 30.

$$\begin{matrix} [ Formula 29 ] & \\ \frac{{n}^{sample} ( {λ}_{p} , x , y ) - {n}^{sample} ( {λ}_{q} , x , y )}{{n}^{sample} ( {λ}_{q} , x , y ) - 1} \sim \frac{{n}^{sample} ( {λ}_{p} , 0 , 0 ) - {n}^{sample} ( {λ}_{q} , 0 , 0 )}{{n}^{sample} ( {λ}_{q} , 0 , 0 ) - 1} \sim \frac{{n}^{sample} ( {λ}_{p} , 0 , 0 ) + δ n ( {λ}_{p} ) - {n}^{sample} ( {λ}_{q} , 0 , 0 ) - δ n ( {λ}_{q} )}{{n}^{sample} ( {λ}_{q} , 0 , 0 ) + δ n ( {λ}_{q} ) - 1} & ( 29 ) \\ ∴ {n}^{sample} ( {λ}_{p} , x , y ) - {n}^{sample} ( {λ}_{p} , 0 , 0 ) = \frac{{n}^{sample} ( {λ}_{p} , 0 , 0 ) + δ n ( {λ}_{p} ) - 1}{{n}^{sample} ( {λ}_{q} , 0 , 0 ) + δ n ( {λ}_{q} ) - 1} ( {n}^{sample} ( {λ}_{q} , x , y ) + {n}^{sample} ( {λ}_{q} , 0 , 0 ) ) & \\ [ Formula 30 ] & \\ \begin{matrix}GI ( {λ}_{q} , x , y ) = {n}^{sample} ( {λ}_{q} , x , y ) + {n}^{sample} ( {λ}_{q} , 0 , 0 ) \\ = \frac{W ( {λ}_{p} , x , y ) - W ( {λ}_{q} , x , y )}{2 π [ ( \frac{{n}^{sample} ( {λ}_{p} , 0 , 0 ) + δ n ( {λ}_{p} ) - 1}{{n}^{sample} ( {λ}_{q} , 0 , 0 ) + δ n ( {λ}_{q} ) - 1} ) \frac{1}{{λ}_{p}} - \frac{1}{{λ}_{q}} ] L ( x , y )}\end{matrix} & ( 30 )\end{matrix}$$

With the refractive index distribution in the target 80 at the q-th wavelength being directly calculated through formula 27, the refractive index distribution GI′(λ_{q},x,y) including an error is calculated by formula 31.

$$\begin{matrix}[ Formula 31 ] & \\ {GI}^{′} ( {λ}_{q} , x , y ) = GI ( {λ}_{q} , x , y ) - δ n ( {λ}_{q} ) ( 1 - \frac{L ( 0 , 0 )}{L ( x , y )} ) & ( 31 )\end{matrix}$$

θ represented by formula 32 is the square of the difference between the refractive index distribution GI(λ_{q},x,y) calculated by formula 30 and the refractive index distribution GI′(λ_{q},x,y) calculated by formula 31. If the refractive index n^{sample}(λ_{q}, 0,0)+δₙ(λ_{q}) of the reference target is calculated so that θ decreases, δₙ(λ_{q})=0 is satisfied and the refractive index n^{sample}(λ_{q},0,0) of the center of the target 80 is calculated. Combining the calculated n^{sample}(λ_{q},0,0) with GI(λ_{q},x,y) enables calculation of the refractive index n^{sample}(λ_{q},x,y) of the target 80 at an optional point (x,y).

[Formula 32]

Θ=[GI′(λ,x,y) . . . GI(λ,x,y)]² (32)

A third exemplary embodiment will be described below. It is possible to feed back a measurement result of the refractive index with the refractive index measurement apparatuses and the refractive index measurement methods according to the first and the second exemplary embodiments into a manufacturing method of an optical element such as a lens.

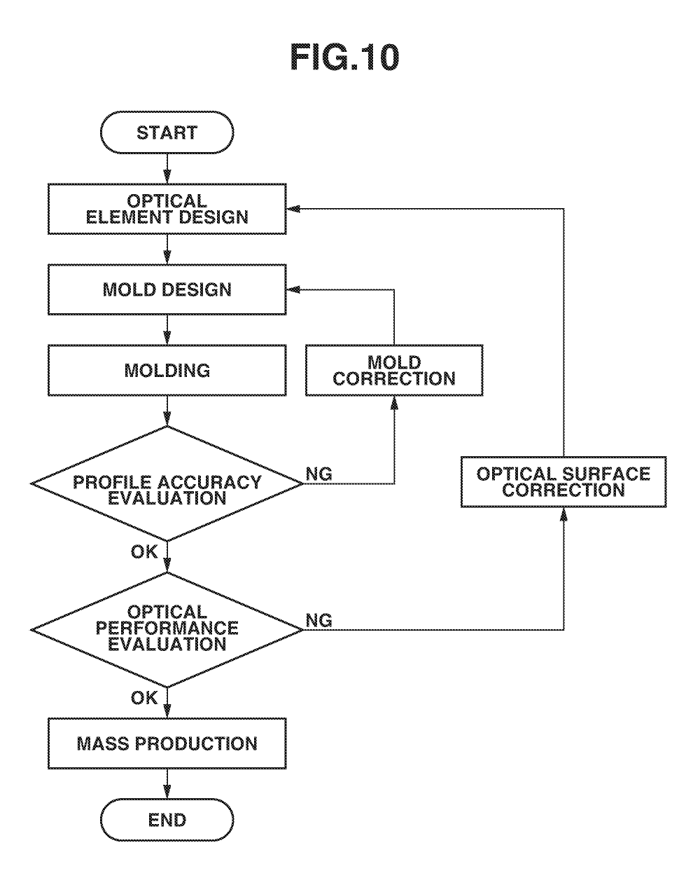

FIG. 10 illustrates an example of optical element manufacturing processes using molding.

An optical element is manufactured through a process for designing an optical element, a process for designing a mold, and a process for molding the optical element using the mold. The shape accuracy of the molded optical element is evaluated. If the accuracy is not sufficient, the mold is corrected and molding is performed again. If the shape accuracy is satisfactory, the optical performance of the optical element is evaluated. Incorporating the refractive index measurement method according to an exemplary embodiment into the optical performance evaluation process enables mass-production of the molded optical element with sufficient accuracy. If the optical performance is low, the optical surface is corrected and then the optical element is redesigned.

The above-described exemplary embodiments are to be considered as representative examples for embodying the present invention, and can be modified and changed in diverse ways.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-091587, filed Apr. 28, 2016, which is hereby incorporated by reference herein in its entirety.

What is claimed is:

1. A refractive index measurement method for measuring a refractive index of a target, using an interference optical system which divides light from a light source having a plurality of discrete wavelengths into test light and reference light, causes the test light to enter a target, and causes the test light transmitted through the target and the reference light to interfere with each other, by measuring a phase of interference light between the test light transmitted through the target and the reference light, the refractive index measurement method comprising:
determining a first optical delay amount of the interference optical system so that, in a case where a difference between optical path lengths of the test light and the reference light with the target being not arranged on an optical path of the test light is defined as an optical delay amount of the interference optical system, a first wavelength being one of the plurality of discrete wavelengths and a second wavelength, different from the first wavelength, being one of the plurality of discrete wavelengths are included in a wavelength range corresponding to a phase having a difference of less than 2π from an extremal value of the phase of the interference light;
measuring a phase of interference light at the first wavelength and a phase of interference light at the second wavelength in a case where the optical delay amount of the interference optical system is the first optical delay amount;
calculating a phase difference between the plurality of discrete wavelengths in a case where the optical delay amount of the interference optical system is a predetermined optical delay amount, using the first optical delay amount, the phase of the interference light at the first wavelength, and the phase of the interference light at the second wavelength; and
calculating the refractive index of the target based on the phase difference between the plurality of discrete wavelengths.

2. The refractive index measurement method according to claim 1, wherein, in a case where the optical delay amount of the interference optical system is the first optical delay amount, a difference between the phase of the interference light at the first wavelength and the phase of the interference light at the second wavelength is less than π.

3. The refractive index measurement method according to claim 1, further comprising:
calculating a change rate of a phase between the first and the second wavelengths using the phase of the interference light at the first wavelength and the phase of the interference light at the second wavelength; and
calculating, by using the change rate of the phase, the phase difference between the plurality of discrete wavelengths in a case where the optical delay amount of the interference optical system is the predetermined optical delay amount.

4. The refractive index measurement method according to claim 1, further comprising:
determining a k-th optical delay amount of the interference optical system so that a k-th wavelength and a (k+1)-th wavelength among the plurality of discrete wavelengths are included in the wavelength range corresponding to a phase having a difference of less than 2π from the extremal value of the phase of the interference light, wherein k is an integer;
measuring a phase of interference light at the k-th wavelength and a phase of interference light at the (k+1)-th wavelength in a case where the optical delay amount of the interference optical system is the k-th optical delay amount; and
calculating, using the k-th optical delay amount, the phase of the interference light at the k-th wavelength, and the phase of the interference light at the (k+1)-th wavelength, a phase difference between the plurality of discrete wavelengths in a case where the optical delay amount of the interference optical system is the predetermined optical delay amount.

5. The refractive index measurement method according to claim 4, further comprising determining the k-th optical delay amount of the interference optical system using a sum of an intensity of the interference light at the k-th wavelength and an intensity of the interference light at the (k+1)-th wavelength.

6. The refractive index measurement method according to claim 1, further comprising:
measuring a wavefront aberration of the test light transmitted through the target at two wavelengths among the plurality of discrete wavelengths;
calculating a difference in wavefront aberration between the two wavelengths;
calculating a refractive index distribution in the target using the difference in wavefront aberration and a phase difference between the two wavelengths; and
calculating the refractive index of the target by using the wavefront aberration and the refractive index distribution.

7. An optical element manufacturing method comprising molding an optical element, and evaluating optical performance of the molded optical element by measuring a refractive index of the optical element,
wherein a refractive index measurement method for measuring the refractive index of the optical element uses an interference optical system which divides light from a light source having a plurality of discrete wavelengths into test light and reference light, causes the test light to enter an optical element, and causes the test light transmitted through the optical element and the reference light to interfere with each other, to measure a phase of interference light between the test light transmitted through the optical element and the reference light, the refractive index measurement method comprising:
determining a first optical delay amount of the interference optical system so that, in a case where a difference between optical path lengths of the test light and the reference light with the optical element being not arranged on an optical path of the test light is defined as an optical delay amount of the interference optical system, a first wavelength being one of the plurality of discrete wavelengths and a second wavelength, different from the first wavelength, being one of the plurality of discrete wavelengths are included in a wavelength range corresponding to a phase having a difference of less than 2π from an extremal value of the phase of the interference light;
measuring a phase of interference light at the first wavelength and a phase of interference light at the second wavelength in a case where the optical delay amount of the interference optical system is the first optical delay amount;
calculating a phase difference between the plurality of discrete wavelengths in a case where the optical delay amount of the interference optical system is a predetermined optical delay amount, using the first optical delay amount, the phase of the interference light at the first wavelength, and the phase of the interference light at the second wavelength; and
calculating the refractive index of the optical element based on the phase difference between the plurality of discrete wavelengths.

8. A refractive index measurement apparatus comprising:
a light source configured to emit light having a plurality of discrete wavelengths;
an interference optical system configured to divide the light from the light source into test light and reference light, cause the test light to enter a target, and cause the test light transmitted through the target and the reference light to interfere with each other;
a detector configured to detect interference light obtained by the interference of the test light and the reference light caused by the interference optical system; and
a computer configured to calculate a refractive index of the target using the phase of the interference light detected by the detector,
wherein, by using a first optical delay amount of the interference optical system determined so that, in a case where a difference between optical path lengths of the test light and the reference light with the target being not arranged on an optical path of the test light is defined as an optical delay amount of the interference optical system, a first wavelength being one of the plurality of discrete wavelengths and a second wavelength, different from the first wavelength, being one of the plurality of discrete wavelengths are included in a wavelength range corresponding to a phase having a difference of less than 2π from an extremal value of the phase of the interference light, and by using a phase of interference light at the first wavelength and a phase of the interference light at the second wavelength measured in a case where the optical delay amount of the interference optical system is the first optical delay amount, the computer calculates a phase difference between the plurality of discrete wavelengths in a case where the optical delay amount of the interference optical system is a predetermined optical delay amount, and calculates the refractive index of the target based on the phase difference between the plurality of discrete wavelengths.
